(19) United States
(12) Patent Application Publication
(10) Pub. No.: US 2002/0124077 A1
(43) Pub. Date: Sep. 5, 2002

(54) Advertising and audience authentication with server-side measurement and client-side verification

(76) Inventors: Clarke Randolph Hill, Portland, OR (US); Aaron D. Starr, Portland, OR (US)

Correspondence Address: IPSOLON LLP, 805 SW BROADWAY, #2740, PORTLAND, OR, 97205, US

(21) Appl. No.: 09/789,433

(22) Filed: Feb. 20, 2001

(51) Int. Cl. G06F 15/173

(52) U.S. Cl. 709/224

(57) ABSTRACT

A traffic authentication method and related computer-implemented software provide authenticated information about audio or video program traffic transmitted over a computer network from a media server. The invention combines server-side measurement with client-side sampled verification. The server-side measurement provides a complete and accurate measurement of audience size for media traffic transmitted from the server. The client-side sampled verification provides sampled corroboration of the veracity or accuracy of part of the transmitted media traffic. One method implementation includes forming at the media server a media census of media segments (e.g., advertisements) transmitted over a computer network from the media server, forming at one or more client computers media segment receipts that identify media segments transmitted to the one or more client computers from the media server; and correlating the media census with the media segment receipts to provide verification of the media census.

### FIELD OF THE INVENTION

The present invention relates to measuring media traffic of audio or video programming (e.g, advertisements) delivered over a computer network and, in particular, to providing measurement and sampled verification of such advertising media traffic.

### BACKGROUND AND SUMMARY OF THE INVENTION

In many countries, conventional broadcast radio and television programming are supported by advertising in the form of commercials that are interspersed throughout the programming. The costs for advertising during different radio and television shows depend upon sampled measurements of the numbers of people who listen to or watch those shows. (For purposes of simplicity, listeners and viewers are both referred to as viewers herein.) The most famous sampled measurements for programming are the Nielson ratings provided by Nielsen Media Research, Inc. and the Arbitron ratings provided by the Arbitron Company.

Transmission of audio and video programming over computer networks, such as the Internet, has become widely available and is becoming increasingly popular. Much of this online programming is being supported by advertising similar to the manner that advertising supports conventional broadcast programming. As with conventional broadcast programming, advertising costs are based upon measuring the numbers of users. As with conventional broadcast programming, measurement of numbers of viewers of online programming is typically conducted by sampled measurements and surveys.

Such sampled measurement of the viewers of online programming suffers from the disadvantage that many online broadcast programming sites might have insufficient traffic to be accurately measured by such sampling. Moreover, such sampling is not an actual measurement or census of audience size, but rather is merely an estimate that is extrapolated from a small representative sample. Sampling also fails to utilize computer network transmission information that is commonly available in the form of network server log files. However, automated monitoring of conventional broadcast advertisements at a receiver has been described by Adlink Information Network, Inc. of Pasig City, Phillipines, www.adlink.com.ph.

A conventional log file typically includes a simple text listing of each file (e.g., media stream) that is transmitted by a media server to a client computer. A conventional log file typically will include information such as which media stream was transmitted (or requested), a network address (e.g., TCP/IP) identification of the client computer that requested (or to which was transmitted) the media stream, and the network browsing software and operating system of the client computer.

Typically, a conventional server log file is readily available to the operator of a server computer so that access to and usage of the server can be monitored. Numerous software utilities are available to provide summaries of usage information included in conventional server log files. Such usage information can be used by the operator of a server computer to discern usage patterns and correlate them with various business or marketing factors.

With advertiser support of a broadcast network site, both the advertisers and the operator of a server have direct economic interests in a conventional log file because advertising rates are typically tied directly to the sizes and types of viewer audiences (i.e., viewer traffic). For example, advertisers need confirmation their advertisements were actually transmitted or “placed.” However, the ready accessibility to and potential for improper manipulation of conventional log files by the operators of servers can render them an unreliable indication of viewer traffic from an advertiser's perspective. As a consequence, advertisers resort to sampled audience or traffic measurements by third parties to obtain objective measurements. Furthermore, log files typically cannot include information on advertisements that are included in or associated with live computer network broadcasts because the log file simply lists the live broadcast stream as a URL and does not report on any information within the stream.

In accordance with the present invention, a traffic authentication method and related computer-implemented software provide authenticated information about audio or video program traffic transmitted over a computer network from a media server. In one implementation, the audio or video program traffic could be or include advertisements. The invention combines server-side measurement with client-side sampled verification. The server-side measurement provides a complete and accurate measurement of the audience that receives the advertising media traffic. The client-side sampled verification provides sampled corroboration of the veracity or accuracy of part of the transmitted advertising media traffic.

One method implementation includes forming at the media server a media census of media segments (e.g., advertisements) transmitted over a computer network from the media server, forming at one or more client computers media segment receipts that identify media segments transmitted to the one or more client computers from the media server; and correlating the media census with the media segment receipts to provide verification of the media census.

A major difference between the operation of the present invention and conventional sampling measurement systems is that the sampling in this invention is directed. While other sampling systems measure the actions of users who are supposedly representative of a larger group, the sampling in this invention monitors a server for the purpose of determining what media segments are returned to the client. This invention does not rely upon the actions of a selected few users being statistically generalized to a much larger group. Instead, the sampling of this invention confirms the veracity of an actual measurement determination made at the transmitting server.

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1 is a block diagram illustrating a computer network architecture as an operating environment for the present invention.

FIG. 2 is a flow diagram of a server-side media transmission census method for measuring media traffic transmitted from a server computer.

FIG. 3 is a flow diagram of a client-side media verification sampling method for sampling media traffic transmitted from a server computer to provide independent and secure verification of server traffic.

FIG. 4 is a flow diagram of a media census verification method for verifying a media census of traffic transmitted from a server computer with regard to client-side media verification sampling.

### DETAILED DESCRIPTION OF PREFERRED EMBODIMENTS

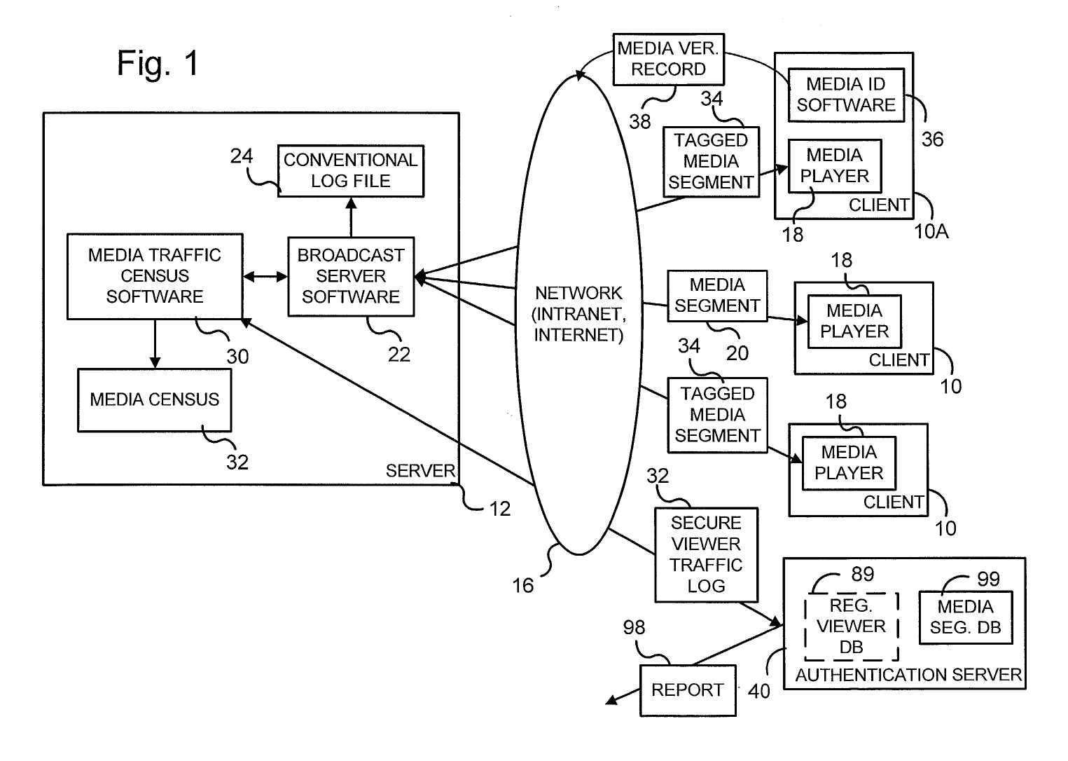

FIG. 1 is a block diagram illustrating a computer network architecture as an operating environment for the present invention. Multiple client computers or clients 10 are in communication with a server computer or server 12 via a network 16, such as a LAN, WAN, an intranet, or the Internet. Clients 10 and server 12 have, for example, conventional computer configurations that each may include a high speed processing unit (CPU) in conjunction with a memory system (with volatile and/or nonvolatile memory), an input device, and an output device, as is known in the art. Server 12 may be implemented as one or more server computers, which in the latter case may communicate with each other over one or more local or remote networks.

Each of clients 10 is a computer, such as a personal computer or computing device (e.g., handheld or embedded, such as network enabled stereo, television, car radio, etc.), running media player software 18 capable of playing or rendering graphic, audio or video files or portions of them (referred to as media segments 20). For example, media player software 18 may be Real Player™ from RealNetworks, Inc. of Seattle, Wash. or Windows Media Player™ from Microsoft Corporation of Redmond, Wash. It will be appreciated that media player software 18 may be integral with or a plug-in added to commercially available network browser software, such as Netscape Navigator from Netscape Corporation or Internet Explorer from Microsoft Corporation, or may be an entirely separate application.

Server 12 is a computer with media broadcast server software 22 that provides serialized media, such as audio, video, or other media segments, to multiple client computers 10. For example, the serialized media may be in a streaming file format or in a serialized meta-file format in which an audio or video presentation may include multiple media segments. Examples of streaming file formats include RealMedia file formats promulgated by RealNetworks, Inc. An example of a serialized meta-file format is the SMIL (Synchronized Multimedia Integration Language) file format, which is sometimes referred to as a multimedia layout and integration language.

Server 12 is illustrated as being an originating server from which serialized media are transmitted. It will be appreciated, however, that server 12 could alternatively operate as a caching server or router that transmits serialized media received from another originating server. Accordingly, the present invention may be applied interchangeably or cumulatively to originating and caching servers.

Typically, a conventional log file 24 is generated by media broadcast server software 22 as it transmits media segments 20 to clients 10. Conventional log file 24 typically includes a simple text listing or record of each media segment 20 that is transmitted by broadcast server software 22. Typically, conventional log file 24 will have a format such as:

192.168.1.111 - - [21/Jul/2000:16:00:38 -0700] “GET g2video.rm RTSP/1.0” 200 261409 [WinNT_{—}4.0_{—}6.0.6.94_play32_RN6C_en-US_{—}686] [3f13ec98-2af0-11d4-9508-00b0d02359b1] [Stat1: 91 0 0 0 0 6_Kbps_Music][Stat2: 6000 15076 0 0 0 0 0 0 0 0 47 6_Kbps_Music] 1273163 59 14 0 0 1

and will include information such as which media segment 20 was transmitted (or requested), a network address (e.g., TCP/IP) identification of the client 10 that requested (or to which was transmitted) media segment 20, or its component, the network browsing software and operating system of client 10, etc.

Typically, conventional server log file 24 is readily available to the operator of server 12 so that access to and usage of server 12 can be monitored. Numerous software utilities are available to provide summaries of usage information included in conventional server logs 24. Such usage information can be used by the operator of a server computer to discern usage patterns and correlate them with various system diagnostics or business or marketing factors, as is known in the art.

With conventional computer network sites (sometimes called Web sites, in reference to the World Wide Web of the Internet), such usage information is often of primary economic interest to the operator of the server. In some instances of server 12 operating broadcast server software 22, the broadcasting of media segments 20 is supported by advertisers who pay the media broadcaster to transmit information such as advertisements with other media segments 20 that are directed to viewers. The broadcaster may be the operator of server 12 or may be a provider or owner of media segments 20 that is distinct from the operator of server 12, in which case the operator of server 12 may be a service provider for the broadcaster. For reference purposes, persons who listen to audio media or who view video media are referred to herein collectively and interchangeably as viewers. Advertiser payments to the broadcaster commonly relate to the numbers of viewers to whom media segments 20 are broadcast from server 12.

In these instances, both the advertisers and the operator of server 12 have direct economic interests in the information in conventional log file 24 because advertising rates and charges are typically tied directly to the sizes and types of viewer audiences (i.e., viewer traffic). However, the ready accessibility to and potential for improper manipulation of conventional log files 24 by the operator of server 12 can render log files 24 an unreliable indication of viewer traffic.

Accordingly, one way to measure viewer traffic reliably is to obtain on server 12 authenticated or secure information about media segments 20 (e.g., advertising media) that are being transmitted, as described in U.S. patent application Ser. No. 09/681,015 of Hill et al., assigned to the assignee of the present invention. While providing an effective, secure and reliable determination of viewer traffic, obtaining authenticated or secure information transmission information on a server 12 can sometimes require valuable system resources.

More specifically, the primary function of a server 12 commonly is to transmit media segments 20 to clients 10. Each server 12 is capable of simultaneously transmitting media segments to numerous clients 10. In some circumstances, however, the numbers of clients 10, the volume of data included in media segments 20, and the expense of servers 12 can combine to make the transmission capacity of each server 12 a valuable and limited system resource. Any sustained computational load or overhead on such a server, such as a secure manner of determining viewer traffic, can undesirably reduce the size of an audience to which the server can transmit.

The present invention provides an effective, secure and reliable determination of viewer traffic while minimizing the computational resources or processing required on a server 12. Such viewer traffic determinations are achieved by separating processor- or resource-intensive verification from total audience measurement, and then correlating the audience measurement with the verification sampling. As a result, the system resources required from servers 12 are minimized while effective, secure and reliable determinations are made of viewer traffic, such as advertisements.

Accordingly, media server 12 includes server-side media traffic census software 30 that operates in conjunction with media broadcast server software 22. Server media census software 30 generates a secure media census 32 that is distinct from conventional log 24 and provides identification and a complete count, listing, or record of all tagged media segments 34 that are transmitted from server 12. By measuring the media segments that are transmitted, this invention provides a complete and accurate measurement of the audience that receives the media segments. Although applicable to media without regard to its content, the following description is directed to an implementation in which taqged media segments 20 are or include advertisements.

Tagged advertising media segments 34 may include tag information or have separate tag information associated with them. For example, tag information that is included in tagged media segments 34 will have no or sufficiently simple encryption so that the tag information may be read or obtained from tagged advertising segments 34 with minimal system resources of server 12. Such tagged advertising segments 34 may therefore be considered not to be securely encrypted. Tag information included in tagged advertising segments 34 may be implemented as meta-tags that include a FILE ID meta-tag that uniquely identifies the advertising media segment 34 by, for example, a universally or globally unique identifier (GUID) or an identifying string.

In other implementations, the tag information may be associated with, but not included in, the tagged advertising segments 34. For example, the audio or video characteristics of each tagged advertising segment 34 can uniquely and concisely identify it, creating a media “fingerprint” which can be used to look up and retrieve the ad information (title, owner, etc) from a database. One implementation of such media “fingerprinting” is described by Adlink Information Network, Inc. of Pasig City, Phillipines, www.adlink.com.ph.

Advertising media census 32 corresponds to a total audience measurement of the tagged advertising segments 34 and could include for each tagged advertising segment 34 an advertisement identifier that is obtained from tag information and uniquely identifies the advertising media segment, a client destination indication (e.g., a network address) identifying the client 10 to which the advertising segment 34 is transmitted, and a time indicator representing a time when the advertising segment 34 was transmitted. Also, all of advertising media census 32 or each record in it may be associated with a media server identifier, such as network address for server 12. Typically, media census 32 will be protected with encryption or other security.

Server advertising media census software 30 alone will provide a tally of purported advertising media transmission. To verify the authenticity of such purported transmissions, at least one selected sampling or “panel” client 10A (only one shown, though typically there would be multiple) includes client media identifying software 36. For tagged advertising segments 34 received from server 12, client advertising media identifying software 36 determines an advertising media source identifier (e.g., a network IP address for server 12), reads or obtains the tag information, and associates them with a client identifier (e.g., a network IP address) that identifies the client 10A and a time indicator representing a time when client 10A received the tagged advertising segment 34, thereby to form a client advertising media verification record 38.

Client advertising media identifying software 36 transmits client media verification record 38 over network 16 to an advertisement traffic authentication server 40, which typically would be operated by a party other than the operator of server 12. In addition, server 12 transmits advertising media census 32 over network 16 to advertisement traffic authentication server 40, which correlates client media verification record 38 with advertising media census 32 to authenticate a sampling of the purported advertising media transmissions included in media census 32.

For example, advertisement traffic authentication server 40 may correlate an advertising media census 32 and a client media verification record 38 by their media server identifier and media source identifier, respectively. Advertisement traffic authentication server 40 may then verify or authenticate that an advertising media segment transmission in media census 32 is corroborated by a corresponding a client media verification record 38.

If every client 10 included client media identifying software 36, advertisement traffic authentication server 40 would be able to verify every purported advertising media transmissions included in advertising media census 32. Although being possible, such an implementation would likely be cumbersome and difficult to implement. As a preferred alternative, the present invention could be implemented with only a subset of clients 10 including client media identifying software 36.

In this implementation, advertisement traffic authentication server 40 combines the complete measure of tagged advertising segments 34 in advertising media census 32 with a corroboration or verification sampling provided by client media verification records 36 from clients 10A. Accordingly, the percentage of tagged advertising segments 34 that are transmitted to clients 10A and are successfully corroborated or verified may be applied to the complete measure in media census 32, thereby giving an effective, secure and reliable determination of a total number of confirmed advertisements served and a corresponding total audience for the advertisements. Such advertisement traffic determinations may then be made available to advertisers and the operator of server 12 in a secure, impartial manner. Typically, traffic authentication server 40 would receive an advertising media census 32 from each of multiple broadcast servers 12 (only one shown).

Clients 10A can be located anywhere on network 16. In some implementations, clients 10A may be geographically distributed to help maintain their anonymity with respect to servers 12. As described above, client media identifying software 36 reads or obtains tag information for tagged advertising segments 34. In one alternative implementation, client media identifying software 36 may identify tagged advertising segments 34 by obtaining or measuring their audio or video waveforms. Such waveform determinations can accommodate for some transmission errors while still producing high correlation ratings. In another alternative implementation, human operators or monitors at clients 10A can compare each tagged advertising segment 34 as it is played with a corresponding claimed or actual media segment.

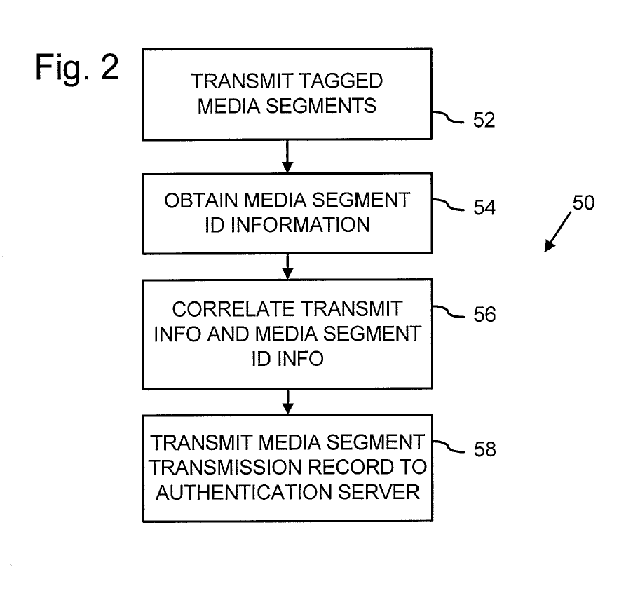

FIG. 2 is a flow diagram of a server-side advertising media transmission census method 50 for measuring advertising media traffic transmitted from a server computer. For purposes of illustration, advertising census method 50 is described with reference the components and structure of computer network 16 and represents one implementation of the operation of media traffic census software 30. In other implementations, the operation of census software 30 may differ from advertising census method 50.

Process block 52 indicates that multiple tagged advertising segments 34 are transmitted from server 12. For example, each tagged advertising segment 34 includes tag information with no or only simple encryption. Alternatively, each tagged advertising segment 34 has tag information that is associated with the segment, but not included in it.

Process block 54 indicates that server 12 reads or obtains advertising media segment identifying information for each tagged advertising media segment 34 that is transmitted. The media segment information is capable of uniquely identifying each tagged advertising media segment 34.

Process block 56 indicates that server 12 correlates advertising media segment transmission information with the media segment identifying information to form an advertising media segment transmission record. The advertising media segment transmission information uniquely identifies or distinguishes the media segment transmission event and may include, for example, a client destination indication (e.g., a network IP address) identifying the client 10 to which the media segment is transmitted and a time indicator representing a time when the advertising media segment was transmitted.

Process block 58 indicates that server 12 transmits the advertising media segment transmission record to advertising traffic authentication server 40, together with a server identifier that identifies server 12. The server identifier may be separately associated with each media segment transmission record or may be associated with a “batch” of multiple media segment transmission records. Similarly, one or more media segment transmission records may be transmitted at a time. Typically, multiple media segment transmission records will be transmitted as a batch representing multiple media segment transmission events that occur over a selected time period (e.g., one hour).

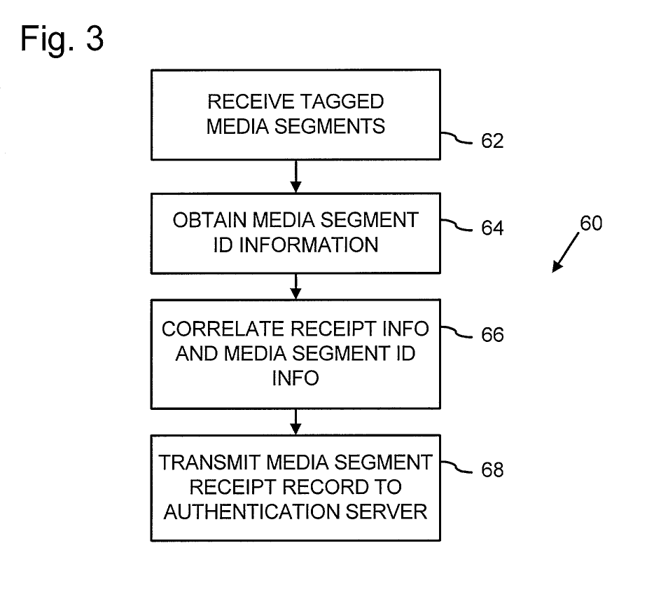

FIG. 3 is a flow diagram of a client-side media verification sampling method 60 for sampling media traffic transmitted from a server computer to provide independent and secure verification of a traffic sample. For purposes of illustration, sampling method 60 is described with reference the components and structure of computer network 16 and represents one implementation of the operation of client media identifying software 36. In other implementations the operation of client media identifying software 36 may differ from sampling method 60.

Process block 62 indicates that a client 10A with client media identifying software 36 receives a tagged advertising media segment 34 from server 12.

Process block 64 indicates that client media identifying software 36 reads or obtains advertising media segment identifying information for each tagged advertising media segment 34 that is received.

Process block 66 indicates that client media identifying software 36 correlates media segment receipt information with the advertising media segment identifying information to form a media segment receipt record. The media segment receipt information uniquely identifies or distinguishes the media segment receipt event and may include, for example, a server source indication (e.g., a network IP address) identifying the server 12 from which the media segment is transmitted and a time indicator representing a time when the media segment was received.

Process block 68 indicates that the media segment receipt record is transmitted from client 10A to advertising traffic authentication server 40, together with a client identifier that identifies client 10A. It will be appreciated that the client identifier may be separately associated with each media segment receipt record or may be associated with a “batch” of multiple media segment transmission records. Similarly, one or more media segment receipt records may be transmitted at a time. Typically, media segment receipt records will be transmitted as a batch representing multiple media segment receipt events that occur over a selected time period (e.g., one hour).

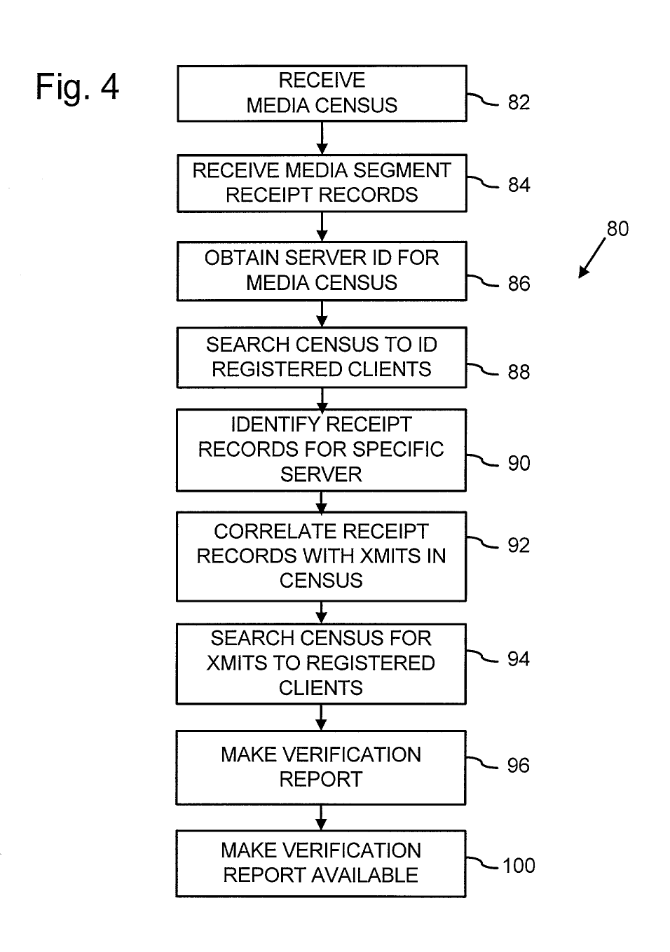

FIG. 4 is a flow diagram of an advertising media census verification method 80 for verifying an advertising media census 32 of traffic transmitted from a server computer with regard to client-side media verification sampling. For purposes of illustration, advertising census verification method 80 is described with reference the components and structure of computer network 16 and represents one implementation of the operation of advertising traffic authentication server 40. In other implementations the operation of advertising traffic authentication server 40 may differ from census verification method 80.

Process block 82 indicates that advertising traffic authentication server 40 receives an advertising media census 32 of traffic transmitted from a server 12.

Process block 84 indicates that advertising traffic authentication server 40 receives multiple media segment receipt records from multiple clients 10A relating to media segment receipt events for advertising media traffic transmitted from multiple servers, including a specific server 12.

Process block 86 indicates that advertising traffic authentication server 40 obtains for advertising media census 32 a media server identifier that identifies specific server 12.

Process block 88 indicates that advertising media census 32 is searched to identify clients 10A that are registered as having client media identifying software 36. For example, clients 10 identified in media census 32 are compared against a sampling client registry or database 89 that is included in or associated with advertising traffic authentication server 40 and lists clients 10A that are registered as having client media identifying software 36.

Process block 90 indicates that advertising traffic authentication server 40 identifies the media segment receipt records relating to advertising media traffic transmitted from specific server 12. For example, searches media source identifiers that are in the media segment receipt records and identifies the server from which advertising media traffic is transmitted to a client 10A.

Process block 92 indicates that the media segment receipt records relating to advertising media traffic transmitted from specific server 12 are correlated with corresponding media transmissions listed in media census 32.

Process block 94 indicates that advertising media census 32 is searched to identify media transmissions that are directed to registered clients 10A but for which there are no corresponding media segment receipt records.

Process block 96 indicates that a verification report 98 is generated representing the extent that advertising media census is confirmed or verified by media segment receipt records. Verification report 98 represents a verification of the accuracy or authenticity of advertising media census 32. It will be appreciated that the information in verification report 98 may be filtered or otherwise adapted to be relevant for particular server operators, advertisers, broadcasters, etc. Such filtering of verification report 98 may be performed with regard to an advertising media segment database 99 in which the media segment identifying information is associated with other information about the advertising media segment, such as its sponsor, creator, date of creation, etc.

Process block 100 indicates that report 98 is provided or made available to subscribers to the media traffic authentication service, including the operator of server 12 and advertisers, or their representatives.

As described above, the present invention readily accommodates verified monitoring of media segments corresponding to untargeted or “universal” advertisements. In universal advertising systems every client 10 receives or “sees” the same advertisement for a given broadcast.

In targeted advertising systems, however, different clients 10 tuned to the same broadcast might receive different media segments (e.g., advertisements). Typically, different media segments (e.g., advertisements) are transmitted to different clients 10 according to demographic information that is associated with the clients. As described above, the present invention can provide a statistical verification of the targeted advertisements being transmitted.

In another implementation, client side verification can be enhanced to provide an improved statistical coverage of broadcasts using targeted advertising. This can be done by creating a group of client verification engines, each representative of a unique individual audience demographic target. Different clients 10A could have selected demographic characteristics associated with them. Alternatively, clients 10A could temporarily have selected demographic characteristics. These different demographic characteristics can create a demographic matrix of different demographic variables (e.g., gender, region, age range) representative of the audience as a whole. Such a matrix can ensure that most advertisements are verified, thereby raising the statistical accuracy of the sampling of targeted advertisements.

It will be appreciated that the sampling by clients 10A with different demographic characteristics need not be performed in a demographically precise manner. The sampling in this invention monitors a server for the purpose of determining what media segments are returned to the client. Sampling by clients 10A with different demographic characteristics functions to provide sampled verification of transmission measurements that purport to be directed to particular demographic groups.

Having described and illustrated the principles of our invention with reference to an illustrated embodiment, it will be recognized that the illustrated embodiment can be modified in arrangement and detail without departing from such principles. It should be understood that the programs, processes, or methods described herein are not related or limited to any particular type of computer apparatus, unless indicated otherwise. Various types of general purpose or specialized computer apparatus may be used with or perform operations in accordance with the teachings described herein. Elements of the illustrated embodiment shown in software may be implemented in hardware and vice versa.

In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

1. A computer-implemented advertising media traffic authentication method for providing authenticated information about audio or video advertising traffic transmitted over a computer network from a media server, the method comprising:
forming at the media server an advertising media census of advertising media segments transmitted over a computer network from the media server;
forming at one or more client computers media segment receipts that identify advertising media segments transmitted to the one or more client computers from the media server; and
correlating the advertising media census with the media segment receipts to provide verification of the media census.

2. The method of claim 1 in which each media segment receipt includes media segment identifying information that uniquely identifies an advertising media segment.

3. The method of claim 1 in which each advertising media segment receipt includes media segment receipt information that includes a server source indication identifying the media server and a time indicator representing a time when the media segment was received.

4. The method of claim 1 further comprising:
transmitting the advertising media census from the media server to an advertising verification server;
transmitting the media segment from the one or more client computers to the verification server; and
correlating the advertising media census with the media segment receipts at the verification server.

5. The method of claim 4 in which the media server is operated by a first party and the advertising verification server is operated by a second party that is separate from the first.

6. The method of claim 1 in which advertising media segments are transmitted from the media server according to demographic characteristics associated with a client computer, the method further comprising assigning each of multiple client computers different demographic characteristics.

7. Advertising media traffic authentication software for providing authenticated information about audio or video advertising traffic transmitted over a computer network from a media server, the method comprising:
server advertising media census software on a media server computer-readable device forming at the media server an advertising media census of advertising media segments transmitted over a computer network from the media server;
client media identifying software on a computer-readable device of each of one or more client computers forming media segment receipts that identify media segments transmitted to the one or more client computers from the media server; and
advertising traffic authentication software on a computer-readable device of an advertising verification server correlating the advertising media census with the media segment receipts to provide verification of the advertising media census.

8. In a computer readable medium, an advertising media segment receipt data structure, comprising:
advertising media segment identifying information that uniquely identifies an advertising media segment received at a client computer from a media server;
a server source indication identifying the media server; and
a time indicator representing a time when the media segment was received at the client computer.

9. A computer-implemented media traffic authentication method for providing authenticated information about audio or video program traffic transmitted over a computer network from a media server, the method comprising:
forming at the media server a media census of media segments transmitted over a computer network from the media server;
forming at one or more client computers media segment receipts that identify media segments transmitted to the one or more client computers from the media server; and
correlating the media census with the media segment receipts to provide verification of the media census.

10. The method of claim 9 in which each media segment receipt includes media segment identifying information that uniquely identifies a media segment.

11. The method of claim 9 in which each media segment receipt includes media segment receipt information that includes a server source indication identifying the media server and a time indicator representing a time when the media segment was received.

12. The method of claim 9 in which the media server transmits tagged media segments that have media segment identifiers that uniquely identify each tagged media segment, and untagged media segments without the media segment identifiers, and in which the media census is formed only with regard to the tagged media segments.

13. The method of claim 12 in which the media segment identifiers are not securely encrypted.

14. The method of claim 12 in which each media segment receipt includes a media segment identifier.

15. The method of claim 12 in which the media segment identifiers are included in the tagged media segments.

16. The method of claim 12 in which the media segment identifiers are associated with, but not included in, the tagged media segments.

17. The method of claim 16 in which the media segment identifiers are stored in a database as unique digital fingerprints that are generated from the media segments.

18. The method of claim 9 further comprising:
transmitting the media census from the media server to a verification server;
transmitting the media segment receipt from the one or more client computers to the verification server; and
correlating the media census with the media segment receipts at the verification server.

19. The method of claim 18 in which the media server is operated by a first party and the verification server is operated by a second party that is separate from the first.

20. The method of claim 9 in which the media server is operated by a first party, and the media census and the media segment are correlated by a second party that is separate from the first.

21. The method of claim 9 in which ones of the media segments are associated together in a serializing media file format.

22. The method of claim 21 in which the serializing media file format includes a streaming media file format.

23. The method of claim 9 in which media segments are transmitted from the media server according to demographic characteristics associated with a client computer, the method further comprising assigning each of multiple client computers different demographic characteristics.

24. The method of claim 9 in which media segments are transmitted from the media server according to demographic characteristics associated with a client computer, the method further comprising assigning a client computer different demographic characteristics at different times.

25. The method of claim 9 in which media segments are transmitted from the media server without regard to demographic characteristics associated with a client computer.

26. Media traffic authentication software for providing authenticated information about audio or video program traffic transmitted over a computer network from a media server, the method comprising:
server media census software on a media server computer-readable device forming at the media server a media census of media segments transmitted over a computer network from the media server;
client media identifying software on a computer-readable device of each of one or more client computers forming media segment receipts that identify media segments transmitted to the one or more client computers from the media server; and
traffic authentication software on a computer-readable device of a verification server correlating the media census with the media segment receipts to provide verification of the media census.

27. The software of claim 26 in which each media segment receipt includes media segment identifying information that uniquely identifies a media segment.

28. The software of claim 26 in which each media segment receipt includes media segment receipt information that includes a server source indication identifying the media server and a time indicator representing a time when the media segment was received.

29. The software of claim 26 in which the media server transmits tagged media segments with media segment identifiers that uniquely identify each tagged media segment, and untagged media segments without the media segment identifiers, and in which the media census is formed only with regard to the tagged media segments.

30. The software of claim 29 in which the media segment identifiers are not securely encrypted.

31. The software of claim 29 in which each media segment receipt includes a media segment identifier.

32. The software of claim 29 in which the media segment identifiers are included in the tagged media segments.

33. The method of claim 29 in which the media segment identifiers are associated with, but not included in, the tagged media segments.

34. The method of claim 33 in which the media segment identifiers are stored in a database as unique digital fingerprints that are generated from the media segments.

35. The software of claim 26 in which the server media census software transmits the media census from the media server to the verification server and the traffic authentication software transmitting the media segment from the one or more client computers to the verification server.

36. The software of claim 35 in which the media server is operated by a first party and the verification server is operated by a second party that is separate from the first.

37. The software of claim 26 in which the media server is operated by a first party, and the media census and the media segment are correlated by a second party that is separate from the first.

38. The software of claim 26 in which ones of the media segments are associated together in a serializing media file format.

39. The software of claim 38 in which the serializing media file format includes a streaming media file format.

40. The software of claim 26 in which media segments are transmitted from the media server according to demographic characteristics associated with a client computer, the client media identifying software further assigning each of multiple client computers different demographic characteristics.

41. The software of claim 26 in which media segments are transmitted from the media server according to demographic characteristics associated with a client computer, the client media identifying software further assigning a client computer different demographic characteristics at different times.

42. The software of claim 26 in which media segments are transmitted from the media server without regard to demographic characteristics associated with a client computer.
